(19) United States
(12) Patent Application Publication
(10) Pub. No.: US 2019/0344168 A1
(43) Pub. Date: Nov. 14, 2019

(54) INTERACTIVE DISPLAY SYSTEM DISPLAYING A MACHINE READABLE CODE

(71) Applicant: SIGNIFY HOLDING B.V., EINDHOVEN (NL)

(72) Inventors: XU ZENG, SHANGHAI (CN); CAIJIE YAN, SHANGHAI (CN); QING LI, SHANGHAI (CN); WENYI LI, SHANGHAI (CN)

(21) Appl. No.: 16/473,098

(22) PCT Filed: Dec. 14, 2017
(86) PCT No.: PCT/EP2017/082751

§ 371 Date: Jun. 24, 2019

(30) Foreign Application Priority Data
Dec. 23, 2016 (CN) PCT/CN2016/111804

(51) Int. Cl. A63F 13/26; G06F 3/01; G06F 3/16; G06F 3/14; G06K 7/14; A63F 13/213; A63F 13/215

(52) U.S. Cl. CPC A63F 13/26; G06F 3/017; G06F 3/167; G06Q 30/0225; G06K 7/1417; A63F 13/213; A63F 13/215; G06F 3/14

(57) ABSTRACT

An interactive display system comprises at least one display unit (3), at least one sensing unit, and at least one control unit. The control unit(s) is/are configured to use the sensing unit(s) to detect a certain combination of user actions, e.g. a combination of a user (51) pointing to an area of the display unit(s) and a user action of a different type, and to use the display unit(s) to display a machine readable code, e.g. a QR code, in dependence on the certain combination of user actions being detected.

### FIELD OF THE INVENTION

The invention relates to an interactive display system.

The invention further relates to a method of enabling interaction with an interactive display system.

The invention also relates to a computer program product enabling a computer system to perform such a method.

### BACKGROUND OF THE INVENTION

Traditional electrical lighting has been around for more than hundred years. Nowadays, lighting systems are frequently smarter than in the past and are increasingly connected to a computer network, e.g. the Internet. For example, people can turn on their lighting remotely before they arrive home. Street lights can automatically be dimmed when it is late at night and there is little traffic. In shops, light can show customers where they are and how to get to their destination.

Lighting cannot only be used to illuminate areas or objects, but also to convey information. A pixel wall is an example of a lighting system being used to convey information. For example, a pixel wall may display a Quick Response (QR) code to allow customers to obtain more information on advertised products and connect to advertisers. A drawback of conventional pixel walls is that they are not interactive and the attention of passersby is not drawn to a displayed QR code.

An interactive pixel wall would draw more attention from passersby, but if the interaction would be limited to a user having to make a gesture to get the pixel wall to display the QR code, similar to the user having to shake his mobile phone to get his mobile phone to display a payment (e.g. QR) code as described in US20160132864A1, the effect of this interactivity on the amount of passerby attention would be limited.

### SUMMARY OF THE INVENTION

It is a first object of the invention to provide an interactive display system, which is able to draw the attention of more passersby.

It is a second object of the invention to provide a method of enabling interaction with an interactive display system, which helps draw the attention of more passersby.

In a first aspect of the invention, the interactive display system comprises at least one display unit, e.g. a LED pixel wall, at least one sensing unit, e.g. a camera, and at least one control unit configured to use said at least one sensing unit to detect a certain combination of user actions and to use said at least one display unit to display a machine readable code in dependence on said certain combination of user actions being detected.

The inventors have recognized that the attention of more passersby is drawn when a combination of user actions needs to be performed before a machine readable code, e.g. a QR code, is displayed, making it possible to add a kind of game element. The interactive display system may be used to connect customers with companies and may be usable indoor and/or outdoor. For example, at the entrance of a shopping mall, people may be able to interact with a LED pixel wall.

Said combination of user actions may comprise a plurality of user actions which need to be performed simultaneously and which are of a different type. This increases the complexity of the interactivity and may therefore be used to increase the game element of the interaction.

Said plurality of user actions may comprise at least two of: a user pointing to an area of said at least one display unit, a user performing a gesture, and a user producing sound. These types of user actions are relatively easy to perform simultaneously.

A first action of said plurality of user actions may comprise a user pointing to an area of said at least one display unit. This type of action is particularly advantageous, because it also makes use of the display unit of the interactive display system.

A first action and a second action of said plurality of user actions may be required to be performed by different users and said at least one control unit may be configured to use said at least one sensing unit to detect that said first action is performed by a first user and said second action is performed by a second user. By requiring multiple persons to participate in the interaction, it becomes easier to draw the attention of groups of persons.

A first action of said plurality of user actions may comprise a user pointing to an area of said at least one display unit and a second action of said plurality of actions may comprise a user performing a waving gesture. These types of user actions are relatively easy to perform simultaneously.

Said combination of user actions may comprise a user pointing to a first area of said at least one display unit and a user pointing to a second (different) area of said at least one display unit. These user actions may be used to add a game element that depends on the response time of the user(s) interacting with the interactive display system.

Said combination of actions may comprise a user pointing to a first area of turned on pixels of said at least one display unit and subsequently pointing to a second area of turned on pixels of said at least one display unit, said at least one display unit or said at least one control unit being configured to switch off at least some pixels outside said first area when said user needs to point to said first area and switch off at least some pixels outside said second area when said user needs to points to said second area. This enables the implementation of the above-mentioned game element in a relatively simple system, such as a pixel wall. This is especially beneficial if the pixels can only be switched on and off, but also increases the contrast between a lit area and a non-lit area in other cases, e.g. if the pixels can have different colors and/or intensities.

Said at least one display unit or said at least one control unit may be configured to switch off all pixels outside said first area when said user needs to point to said first area and switch off all pixels outside said second area when said user needs to points to said second area. This may be used to optimize the contrast between an area to be touched and other areas.

Said machine readable code may comprise a QR code. The QR code is a popular type of machine readable code, which can be read by many mobile devices.

Said at least one control unit may be configured to generate or obtain said machine readable code in dependence on sensor input received using said at least one sensing unit, said machine readable code depending on said sensor input. This increases the game element of the interactivity, because a better achievement may be rewarded with (more) discount, for example.

Said at least one control unit may be configured to determine a level of user activity and/or a sound level from said sensor input and to generate or obtain said machine readable code in dependence on said level of user activity and/or said sound level. These are advantageous methods of rating an achievement, e.g. more sound or more activity may be considered to be a better achievement.

Said at least one control unit may be configured to display said machine readable code upon in dependence on said certain combination of user actions being detected within a predetermined period of time. This increases the game element of the interactivity.

Said at least one control unit may be configured to receive configuration input from a user and/or an administrator of said interactive display system, said configuration input defining said combination of user actions. In this way, the interactivity can be adapted to the location at which the interactive display system is placed or is going to be placed, e.g. a shopping mall where passersby generally have more time or a train station where passersby general have less time, or even to the capabilities or preferences of a user that is interested in seeing a certain machine readable code.

Said at least one sensing unit may be configured to detect presence, motion, sound and/or environmental characteristics. These sensor inputs may be beneficially used to increase the interactivity of the interactive display system and/or to increase the variety of the interactivity.

In a second aspect of the invention, the method of enabling interaction with an interactive display system comprises using at least one sensing unit to detect a certain combination of user actions and displaying a machine readable code on at least one display unit upon in dependence on said certain combination of user actions being detected. The method may be implemented in hardware and/or software.

In a third aspect of the invention, the interactive display system comprises at least one display unit, at least one sensing unit, and at least one control unit configured to use said at least one sensing unit to detect one or more user actions, to generate or obtain a machine readable code in dependence on said one or more user actions being detected, said machine readable code depending on sensor input received using said at least one sensing unit, and to use said at least one display unit to display said machine readable code.

In a fourth aspect of the invention, the method of enabling interaction with an interactive display system comprises using at least one sensing unit to detect one or more user actions, generating or obtaining a machine readable code in dependence on said one or more user actions being detected, said machine readable code depending on sensor input received using said at least one sensing unit, and displaying said machine readable code.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: using at least one sensing unit to detect a certain combination of user actions and displaying a machine readable code on at least one display unit upon in dependence on said certain combination of user actions being detected.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the interactive display system of the invention;

FIG. 2 is a block diagram of the sensing unit of FIG. 1;

FIG. 3 is a block diagram of the control unit of FIG. 1;

FIG. 4 is a block diagram of the display unit of FIG. 1;

FIG. 5 illustrates coordinate mapping performed by an embodiment of the interactive display system;

FIG. 6 is a flow diagram of the first method of the invention;

FIG. 7 is a flow diagram of a first embodiment of the first method of the invention;

FIG. 8 is a flow diagram of a second embodiment of the first method of the invention;

FIG. 9 is a flow diagram of the second method of the invention; and

FIG. 10 is a block diagram of an exemplary data processing system for performing the method of the invention.

Corresponding elements in the drawings are denoted by the same reference numeral.

### DETAILED DESCRIPTION OF THE DRAWINGS

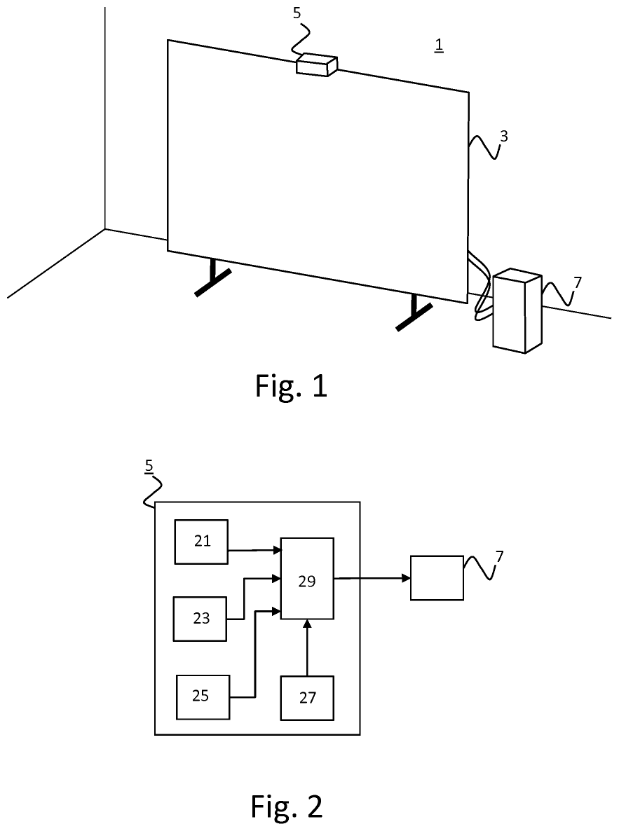

FIG. 1 shows an embodiment of the interactive display system of the invention. The interactive display system 1 comprises a display unit 3 (e.g. a LED pixel wall), a sensing unit 5 (e.g. a camera), and a control unit 7. The control unit 7 is configured to use the sensing unit 5 to detect a certain combination of user actions and to use the display unit 3 to display a machine readable code, e.g. a QR code, in dependence on the certain combination of user actions being detected. In the embodiment of FIG. 1, the sensing unit 5 is placed at the top of the display unit 3. In another embodiment, the sensing unit 5 or another sensing unit may be placed around the display unit 3 and/or behind the display unit 3 (e.g. for touch applications), for example. The sensing unit 5 may be configured to provide received sensor input to the control unit 7 in order to allow the control unit 7 to detect the certain combination of user actions by analyzing the sensor input or the sensing unit 5 may be configured to analyze the received sensor input itself and provide the results of this analysis to the control unit 7.

The combination of user actions may comprise a plurality of user actions which need to be performed simultaneously and which are of a different type. For example, the plurality of user actions may comprise at least two of: a user pointing to an area of the display unit 3, a user performing a gesture, and a user producing sound.

In this embodiment or in a different embodiment, the control unit 7 may be configured to generate or obtain the machine readable code in dependence on sensor input received using the sensing unit 5. The machine readable code depends on the sensor input in this case. If the control unit 7 is configured to detect the certain combination of user actions by analyzing sensor input received by the sensing unit 5, the machine readable code may depend on this same sensor input and/or on further sensor input provided by the sensing unit 5.

For example, the control unit 7 may be configured to determine a level of user activity and/or a sound level from the sensor input and to generate or obtain the machine readable code in dependence on the level of user activity and/or the sound level. The machine readable code may be obtained, for example, by obtaining one of a plurality of images from a memory of the control unit 7 or from a memory of another device, e.g. in a local network or on the Internet. The machine readable code may be generated on the fly with a suitable computer program, for example. In a variant of this embodiment, the control unit 7 is configured to use the sensing unit 5 to detect one or more actions instead of a combination of actions.

In this embodiment or in a different embodiment, the control unit 7 may be configured to receive configuration input from a user and/or an administrator of the interactive display system 1. The configuration input defines the combination of user actions and may be stored in the control unit 7. The configuration input may be received, for example, from a mobile device using a wireless connection, e.g. Wi-Fi, Bluetooth or ZigBee.

In the embodiment shown in FIG. 1, the interactive display system 1 comprises one display unit 3. In an alternative embodiment, the interactive display system 1 comprises multiple display units. In the embodiment shown in FIG. 1, the interactive display system 1 comprises one sensing unit 5. In an alternative embodiment, the interactive display system 1 comprises multiple sensing units. In the embodiment shown in FIG. 1, the interactive display system 1 comprises one control unit 7. In an alternative embodiment, interactive display system 1 comprises multiple control units. In the embodiment shown in FIG. 1, the display unit 3, the sensing unit 5 and the control unit 7 are different devices. In an alternative embodiment, two or three of these units are integrated into a single device.

An embodiment of the sensing unit 5 is shown in FIG. 2. In this embodiment, the sensing unit 5 comprises a presence sensing unit 21, a motion sensing unit 23, an acoustic sensing unit 25, an ambient sensing unit 27 and a data transport interface 29. The presence sensing unit 21 and the motion sensing unit 23 comprise a camera and/or a passive infrared sensor (PIR). The presence sensing unit 21 may be used to count the number of people present. The acoustic sensing unit 25 is configured to detect sound and comprises one or more microphones. The ambient sensing unit 27 is configured to detect environmental characteristics, e.g. light level, temperature and humidity. The data transport interface 29 collects the sensor input from the sensing units 21, 23, 25 and 27 and transmits it to the control unit 7.

The sensing unit 5 may comprise a Kinect sensor from Microsoft, for example. The Kinect sensor includes an IR sensor, a high definition camera and a depth camera. It can detect the presence of up to 6 persons and recognize their activities, like body movement and hand gestures (close, open and lasso).

The sensing unit 5 may provide sensor input to the control unit 7 continuously or only when necessary, for example. For example, the ambient sensing unit 27 might continuously detect the environmental characteristics and provide them as sensor input to the control unit 7, while the presence sensing unit 21 might only provide sensor input to the control unit 7 when presence is detected. The sensing unit 5 may provide the sensor input to the control unit 7 via a wired connection (e.g. USB) or via a wireless connection (e.g. Wi-Fi, ZigBee or Bluetooth).

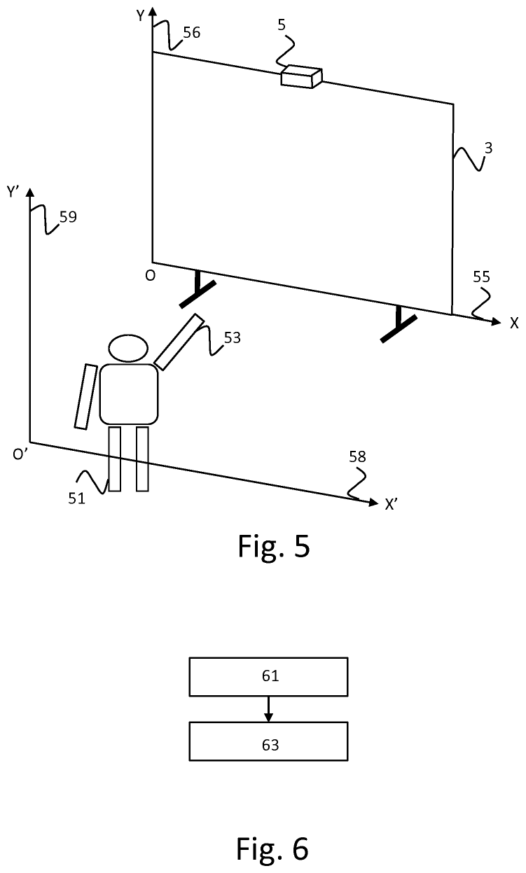

A user may be able to point to an area of the display unit 3 by touching the area or a part of the area, or by pointing to an area of the display unit 3 without touching it. In this case, the distance between the trigger object (e.g. user body, hands and face) and the display unit 3 is more than zero and a coordinate mapping method may be used. This is illustrated in FIG. 5.

In FIG. 5, the coordinates on the display unit 3 are represented as coordinates in a OXY coordinate system (X axis 55 and Y axis 56) and the coordinates at the location of the hand 53 of the user 51 are represented as coordinates in an O′X′Y′ coordinate system (X′ axis 58 and Y′ axis 59). The distance between the trigger object (e.g. the hand 53) and the sensing unit 5 may be used to map the detected location of the trigger object to a position on the display unit 3, for example to ensure that the area (in coordinate system O′X′Y′) in which different positions of the hand 53 are translated to different positions on the display unit 3 does not become too large or too small.

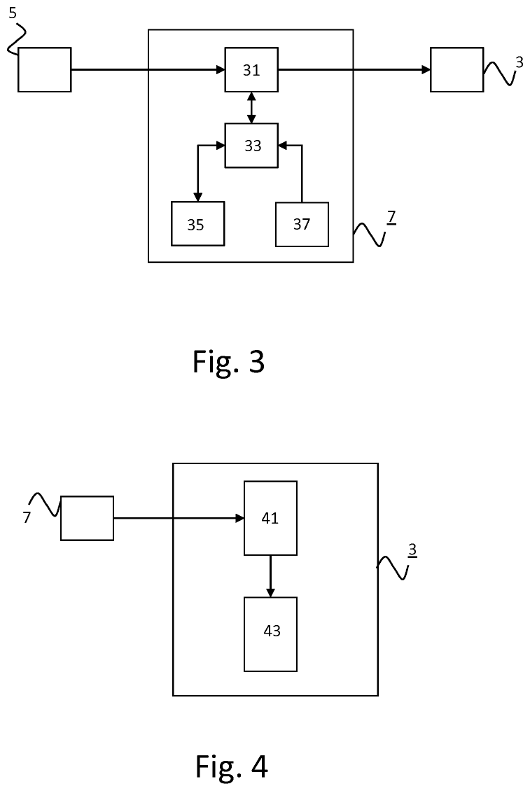

An embodiment of the control unit 7 is shown in FIG. 3. In this embodiment, the control unit 7 comprises an interface unit 31, a processing unit 33, a memory unit 35 and a power supply management unit 37. The interface unit 31 is configured to receive sensor input from the sensing unit 5 and to provide display data to the display unit 3. The processing unit 33 is configured to process the sensor input received by the interface unit 31 and to control the interface unit 31 to provide the display data, e.g. an image showing a QR code, to the display unit 3. The processing unit 33 uses the memory unit 35 to perform this processing while being powered by the power supply unit 37.

The processing unit 33 may be a general-purpose processor, e.g. from Intel, AMD, ARM or Qualcomm, or an application-specific processor. The processing unit 33 may run a Linux or Windows operating system for example. The invention may be implemented using a computer program running on one or more processors. The memory unit 35 may comprise solid state memory (e.g. RAM and/or a Solid State Drive) and/or one or more magnetic or optical discs.

An embodiment of the display unit 3 is shown in FIG. 4. In this embodiment, the display unit 3 comprises a display control unit 41 and a pixel array 43. The display unit 3 may comprise a LED pixel wall, which are generally low cost, and/or a large size TV or monitor, which are generally more complex and more expensive. The TV or monitor may be an LCD TV or monitor with a LED backlight or an OLED TV or monitor, for example. The display control unit 41 receives display data from the control unit 7.

This display data may comprise a low resolution image for a LED pixel wall or a high resolution image for a large size monitor, for example. Alternatively, the display data may comprise instructions for a plurality of light sources, for example. The display control unit 41 may receive display data from the control unit 7 via a wired connection (e.g. VGA, HDMI, DVI or DisplayPort) or via a wireless connection (e.g. WiFi, or Wireless HDMI). Light sources of a LED pixel wall may be connected (partly) in sequence and/or (partly) in parallel to the display control unit 41. If a simple wired connection is used, a proprietary control signal may comprise one or more RGB values for one or more connected light sources, for example.

A first method of enabling interaction with an interactive display system comprises at least two steps, see FIG. 6. A step 61 comprises using at least one sensing unit to detect a certain combination of user actions. A step 63 comprises displaying a machine readable code on at least one display unit upon in dependence on the certain combination of user actions being detected.

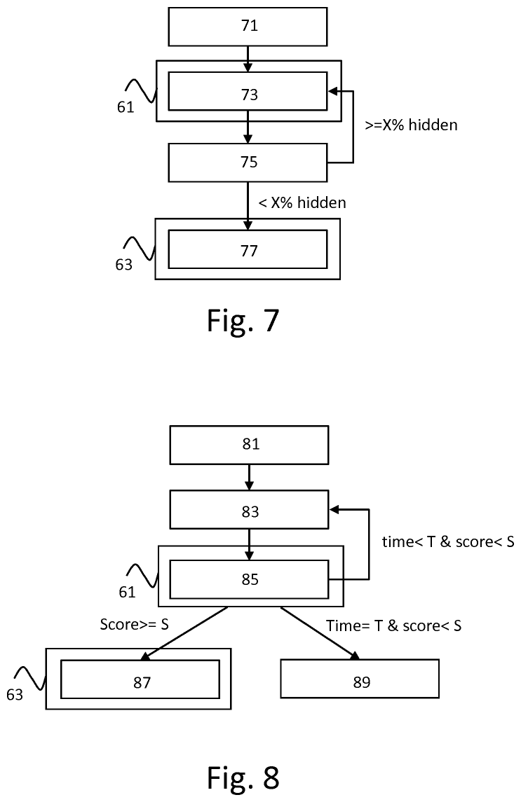

Preferably, a first action of the plurality of user actions comprises a user pointing to an area of the at least one display unit, as described in relation to the embodiments of FIG. 7 and FIG. 8.

A first embodiment of the first method of enabling interaction with an interactive display system is shown in FIG. 7. In this first embodiment, a first action of the plurality of user actions comprises a user pointing to an area of the at least one display unit and a second action of the plurality of actions comprises a user performing a waving gesture.

In the first embodiment, people stand several meters (e.g. 0.5˜5 m) in front of a LED pixel wall. A Kinect sensor is used to track the movement of someone's hand. In step 71, a picture, e.g. a photo, is displayed on the LED pixel wall. When the Kinect sensor detects that someone is standing before the LED pixel wall, a voice output by a speaker asks people to wave their hands. A user standing in front of the LED pixel wall then starts waving one of his hands. In step 73, which is an embodiment of step 61, the moving path of the hand is recorded and a mapping between movement path and the LED pixel wall is determined as described in relation to FIG. 5.

Next, a part of a QR code is displayed in step 75 in the area corresponding to the track of hand instead of the original picture, as if the hand ‘erases’ part of the picture and the QR code ‘hidden’ behind the picture appears. Multiple users may wave their hands simultaneously. As the user(s) wave their hand(s), more parts of the picture are erased and the complete QR code is gradually displayed on the LED pixel wall. If X % or more (X could be 10, 20 or 30, for example) of the QR code is still hidden, step 73 is repeated after step 75. If less than X % of the QR code is hidden, the complete QR code is displayed instead of the original picture in step 77, which is an embodiment of step 63. The QR code may relate to commercial information, for example.

A second embodiment of the first method of enabling interaction with an interactive display system is shown in FIG. 8. In this second embodiment, the combination of user actions comprises a user pointing to a first area of the at least one display unit and a user pointing to a second area of the at least one display unit. Furthermore, in this embodiment, the at least one control unit is configured to display the machine readable code upon in dependence on the certain combination of user actions being detected within a predetermined period of time.

In the second embodiment, a user touches the at least one display unit to interact with it. In step 81, a timer is displayed at the top of the LED pixel wall, showing the time that is left to finish the game or the time spent on the game and an end time T. Other parts of the LED pixel wall are unlit. In step 83, when people get close to the LED pixel wall, an area of the screen which contains several pixels is lit with a random color at a random position. The size of the block could be 2×2 pixels, 3×3 pixels or 4×4 pixels, for example. When someone touches the lit area, the light behind the lit area and/or the pixels that form the area are turned off and another area with the same size or with a different size is displayed at a random position with a random color on the LED pixel wall in step 85, which is an embodiment of step 61.

The time that is left to finish the game decreases while time passes. If the user touches a lit area more than N times before the time spent on the game has reached end time T, the game is won and the time spent on the game or the score is displayed on the screen in step 87, which is an embodiment of step 63. Furthermore, a QR code (which encodes shopping mall information or discount coupons, for example) is displayed below the time. The QR code may depend on the time spent on the game or the number of lit areas touched before the end time T. For example, if a user finishes the game in a shorter time or with a higher score, a QR code with bigger discount coupon may be displayed. If the time spent on the game has not reached end time T yet and optionally, if the user has not touched a lit area more than N times, step 83 is repeated after step 85. If the time spent on the game reaches end time T and the user has not touched a lit area more than N times, the word “YOU LOSE” are displayed below the time instead of a QR code in step 89. Instead of one user playing the game, multiple users may try to touch a lit area at the same time or alternately.

In other words, in the second embodiment, the combination of actions comprises a user pointing to a first area of turned on pixels of the at least one display unit and subsequently pointing to a second area of turned on pixels of the at least one display unit and the at least one display unit or the at least one control unit is being configured to switch off at least some (preferably all) pixels outside the first area when the user needs to point to the first area and to switch off at least some pixels (preferably all) outside the second area when the user needs to points to the second area.

In a third embodiment of the first method (not separately depicted), a first action and a second action of the plurality of user actions are required to be performed by different users. The at least one control unit is configured to use the at least one sensing unit to detect that the first action is performed by a first user and the second action is performed by a second user. In the third embodiment, a red heart is displayed on the at least one display unit. When two persons form a “heart shape” with their arms and hands, a camera takes a photo of them while performing these gestures and makes the photo accessible on the Internet. A QR code is then displayed on the at least one display unit and the two persons can download this photo by scanning the QR code.

In a fourth embodiment of the first method (not separately depicted), passersby can use the interactive display system to play a Tetris game, in which lines need to be completed with tetromino shaped blocks. A user can use four types of gestures to affect the blocks. Waving a left hand can move the block left. Waving a right hand can move the block right. Pushing both hands forward can rotate the block. A squat gesture results in the block falling fast. After the game has finished, e.g. an end time T has been reached, a QR code will be displayed on the at least one display unit. The higher the score, the higher the discount the QR code will represent.

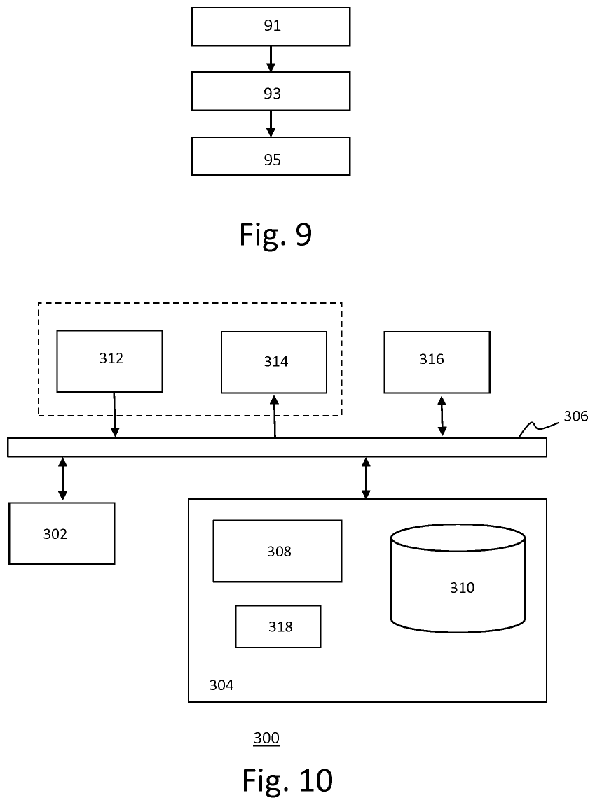

A second method of enabling interaction with an interactive display system comprises at least three steps, see FIG. 9. A step 91 comprises using at least one sensing unit to detect one or more user actions. A step 93 comprises generating or obtaining a machine readable code in dependence on the one or more user actions being detected. A dependency between the machine readable code and the one or more user actions may be self-defined by an administrator or the user of the system. The machine readable code may include different information, for example different discount rate in dependence on the one or more user actions being detected and/or sensor input received using the at least one sensing unit. A step 95 comprises displaying the machine readable code. For example, a user may need to make a waving gesture a certain period of time in order to get the machine readable code to be displayed to him and the machine readable code may depend on how fast the user waved.

In an embodiment of the second method, a random gesture is displayed on a screen (e.g. a graphic or image showing a person pointing one arm up and one arm down is displayed). A user is asked to pose the same gesture as displayed on the screen. The camera will take a photo of the user and by image analysis, the interactive display system determines whether the gesture of the user matches at least to a certain degree with that displayed on the screen. If such a match is determined to be present, a QR code will be displayed on the screen. The QR code depends on how well the gesture of the user matches with that displayed on the screen. In this case, the QR code includes different discount information depending on how well the gesture of the user matches with that displayed on the screen. For example, if it is judged that the gesture of the user 50% matches with that displayed on the screen, the QR code with a 20%-off coupon will be generated, and if 70% matches, the QR code with a 30%-off coupon will be generated. The user can then scan the QR code to get the coupon.

FIG. 10 depicts a block diagram illustrating an exemplary data processing system that may perform the method as described with reference to FIGS. 6 to 9.

As shown in FIG. 10, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 10 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 10, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 10) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. An interactive display system, comprising:
at least one display unit;
at least one sensing unit; and
at least one control unit configured to use said at least one sensing unit to detect a certain combination of user actions and to use said at least one display unit to display a machine readable code in dependence on said certain combination of user actions being detected;
wherein said at least one control unit is configured to generate or obtain said machine readable code in dependence on user actions being detected, and a dependency between the machine readable code and the user actions is self-defined; and
wherein said at least one control unit is configured to receive configuration input from a user and/or an administrator of said interactive display system, said configuration input defining said combination of user actions.

2. An interactive display system as claimed in claim 1, wherein said combination of user actions comprises a plurality of user actions which need to be performed simultaneously and which are of a different type.

3. An interactive display system as claimed in claim 2, wherein said plurality of user actions comprises at least two of: a user pointing to an area of said at least one display unit, a user performing a gesture, and a user producing sound.

4. An interactive display system as claimed in claim 1, wherein a first action and a second action of said plurality of user actions are required to be performed by different users and said at least one control unit is configured to use said at least one sensing unit to detect that said first action is performed by a first user and said second action is performed by a second user.

5. An interactive display system as claimed in claim 1, wherein said combination of user actions comprises a user pointing to a first area of said at least one display unit and a user pointing to a second area of said at least one display unit.

6. An interactive display system as claimed in claim 1, wherein said machine readable code comprises a QR code.

7. An interactive display system as claimed in claim 1, wherein said at least one control unit is configured to generate or obtain said machine readable code in dependence on sensor input received using said at least one sensing unit, said machine readable code depending on said sensor input.

8. An interactive display system as claimed in claim 7, wherein said at least one control unit is configured to determine a level of user activity and/or a sound level from said sensor input and to generate or obtain said machine readable code in dependence on said level of user activity and/or said sound level.

9. An interactive display system as claimed in claim 1, wherein said at least one control unit is configured to display said machine readable code upon in dependence on said certain combination of user actions being detected within a predetermined period of time.

10. (canceled)

11. An interactive display system as claimed in claim 1, wherein said at least one sensing unit is configured to detect presence, motion, sound and/or environmental characteristics.

12. (canceled)

13. A method of enabling interaction with an interactive display system, comprising:
receiving configuration input from a user and/or an administrator of said interactive display system, said configuration input defining a combination of user actions;
using at least one sensing unit to detect the certain combination of user actions; and
generating or obtaining a machine readable code in dependence on said combination of user actions, and a dependency between the machine readable code and the user actions is self-defined;
displaying the machine readable code on at least one display unit upon in dependence on said certain combination of user actions being detected.

14. (canceled)

15. A computer program or suite of computer programs comprising at least one software code portion or a computer program product storing at least one software code portion, the software code portion, when run on a computer system, being configured for enabling the method of claim 13 to be performed.
